(19) United States
(12) Patent Application Publication
(10) Pub. No.: US 2009/0271797 A1
(43) Pub. Date: Oct. 29, 2009

(54) INFORMATION PROCESSING APPARATUS, INFORMATION PROCESSING METHOD, AND MEDIUM STORING INFORMATION PROCESSING PROGRAM STORED THEREON

(75) Inventor: Eiichi Nishikawa, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/420,868

(22) Filed: Apr. 9, 2009

(30) Foreign Application Priority Data
Apr. 24, 2008 (JP) 2008-114418

(51) Int. Cl. G06F 9/50; G06F 1/32

(52) U.S. Cl. 718/104; 713/321

(57) ABSTRACT

An information processing apparatus including at least one first processing unit that manages a resource and at least one second processing unit that accesses the resource, wherein the second processing unit stores a table in which an identifier identifying the resource is associated with the resource, and when accessing the resource, refers to the table and requests the first processing unit to allocate the identifier associated with the resource to the resource.

### BACKGROUND OF THE INVENTION

1. Field of the Invention

The present invention relates to information processing apparatuses including a plurality of CPUs, methods for the same, and media storing a program stored thereon.

2. Description of the Related Art

As the consciousness of environmental protection is growing with respect to issues such as the increasing prices of and the exhaustion of energy resources and the increasing global average temperature, reduction of power usage is strongly needed in information processing apparatuses. For example, copiers are provided with power-saving modes called low-power mode, sleep mode, or the like, for reducing the amount of power used in the standby state. To achieve such a power-saving mode, CPUs also have a state called “sleep” in which the amount of used power is restrained.

Currently, a common technique for enhancing the processing performance of an information processing apparatus has been to increase the CPU clock speed. However, with increasingly minute processes and other factors, it has become difficult to readily realize a high clock speed. Therefore, a technique is widely used in which the processing performance of an information processing apparatus is enhanced from the perspective of using a plurality of CPUs to distribute processing, rather than having a sufficiently high CPU clock speed. When such an information processing apparatus including a plurality of CPUs transitions to power-saving mode, not only are all the CPUs transitioned to the sleep state, but also part of the CPUs are further transitioned to the shutdown state. In this manner, more power can be saved.

Generally, an information processing apparatus including a plurality of CPUs often has cases where one CPU accesses and uses a resource, such as a file, managed by another CPU. Various techniques have been developed for this purpose. Japanese Patent Laid-Open No. 2004-30539 describes an information processing apparatus having a plurality of CPUs and storage units, wherein programs can easily be continuously written to storage units that are controlled by different CPUs.

However, there may be a case where the information processing apparatus is externally instructed to transition to power-saving mode, so that a CPU that manages a resource enters the shutdown state while another CPU that accesses the resource enters the sleep state. When the apparatus returns to the normal state from the power-saving mode in which both the sleep-state CPU and the shutdown-state CPU existed, software on the side of the CPU that was in the sleep state resumes in the state just before the transition to the sleep state. On the other hand, software on the side of the CPU that was in the shutdown state resumes in the initial state. Therefore, the side of the CPU that directly manages the resource and the side of the CPU that accesses and uses the resource may resume in different states. This will be specifically described below.

FIG. 11A is a flowchart showing a conventional procedure in which a CPU directly managing resources allocates an identifier to a resource in resource management. As shown in steps S1101 to S1103 of FIG. 11A, identifiers in a certain range (the range up to the maximum identifier shown in FIGS. 11A and 11B) are sequentially searched to extract an unused identifier. Identifiers already in use (reserved identifiers shown in FIGS. 11A and 11B) are skipped. The extracted unused identifier is then allocated to the resource. The identifier allocated to the resource in this manner is returned to a caller (e.g., software on the side of another CPU) that is attempting to access the resource. If no unused identifiers exist, “null” (typically “0”) is returned to the caller. FIG. 11B is an exemplary program code implementing FIG. 11A.

Thus, when a CPU that entered the shutdown state allocates an identifier to a resource, it operates as in FIGS. 11A and 11B. Therefore, the CPU may not necessarily allocate the same identifier to the same resource before and after the shutdown state. On the other hand, software on the side of the CPU that was in the sleep state is generally not aware of whether or not the information processing apparatus entered power-saving mode (the sleep state). Therefore, once it returns from power-saving mode, it resumes in the state before the sleep state. The software attempts to use an identifier before the sleep state to access a resource (e.g., a file in an HDD) controlled by the CPU that was in the shutdown state. However, for the above-described reason, the CPU that was in the sleep state may not be able to access the same resource (file) in the attempt to access the resource (the file in the HDD) controlled by the CPU that was in the shutdown state. That is, after an information processing apparatus including a plurality of CPUs (CPUs that enter the sleep state and CPUs that enter the shutdown state) enters power-saving mode, resources controlled by different CPUs may not be able to be managed with unique identifiers.

The above problem is possible when an information processing apparatus including a plurality of CPUs transitions to power-saving mode. However, Japanese Patent Laid-Open No. 2004-30539 does not particularly mention a method for resource management when returning from power-saving mode in which both a sleep-state CPU and a shutdown-state CPU exist.

Further, an exemplary method for solving the above problem may be to generate a table indicating the correspondence between resources and identifiers and to use the table to access the resources. For example, before the information processing apparatus is externally instructed to transition to power-saving mode and the CPU enters the sleep state, a table that associates currently used resources with identifiers is generated and stored. After the apparatus returns from power-saving mode, software on the side of the CPU that was in the sleep state obtains a new identifier and updates the table every time the software attempts to access a resource controlled by the CPU that was in the shutdown state. The software on the side of the CPU that was in the sleep state can refer to this table to obtain a correct identifier of a desired resource. In this manner, the above problem that arises when resources cannot be managed with unique identifiers can be solved in the case where the information processing apparatus including a plurality of CPUs entered power-saving mode.

However, every time software on the side of the CPU that was in the sleep state accesses a resource, the software needs to refer to the table. This causes a waste of processing time, especially if resources are frequently accessed. Also, such frequent accesses to the table increase the frequency with which a cache system, which is provided generally for preventing a stall of CPU execution by memory access, functions. This decreases the original efficiency of the cache system.

### SUMMARY OF THE INVENTION

The present invention provides an information processing apparatus in which resources controlled by a CPU that enters the sleep state and a CPU that enters the shutdown state can be uniquely managed without increasing the processing load.

The present invention in its first aspect provides an information processing apparatus including at least one first processing unit that manages a resource and at least one second processing unit that accesses the resource, wherein the second processing unit stores a table in which an identifier identifying the resource is associated with the resource, and when accessing the resource, refers to the table and requests the first processing unit to allocate an identifier associated with the resource to the resource.

The present invention in its second aspect provides an information processing method performed in an information processing apparatus comprising at least one first CPU that manages a resource and at least one second CPU that accesses the resource, the method comprises the steps of storing a table in which an identifier identifying the resource is associated with the resource, and a requesting step in which, referring to the table and requesting the first CPU to allocate an identifier associated with the resource to the resource when accessing the resource.

The present invention in its third aspect provides a computer-readable medium storing an information processing program thereon, wherein in a computer comprising at least one first CPU that manages a resource and at least one second CPU that accesses the resource, the program causes the second CPU to function to store a table in which an identifier identifying the resource is associated with the resource, and when accessing the resource, refer to the table and request the first CPU to allocate the identifier associated with the resource to the resource.

According to the present invention, resources controlled by a CPU that enters the sleep state and a CPU that enters the shutdown state can be uniquely managed without increasing the processing load.

Further features of the present invention will become apparent from the following description of exemplary embodiments with reference to the attached drawings.

### BRIEF DESCRIPTION OF THE DRAWINGS

FIG. 1 is a diagram showing an exemplary system including an information processing apparatus in an embodiment according to the present invention;

FIG. 2 is a diagram showing an internal configuration of an MFP serving as the information processing apparatus;

FIG. 3 is a block diagram showing a configuration of a data processing unit including a plurality of CPUs;

FIG. 4 is a flowchart showing a procedure in which the information processing apparatus including a plurality of CPUs transitions to power-saving mode;

FIG. 5 is a flowchart showing a procedure in which the information processing apparatus including a plurality of CPUs returns from power-saving mode;

FIG. 6 is a flowchart showing a procedure for accessing a resource in a configuration including a plurality of CPUs;

FIG. 7 is a flowchart showing a procedure for accessing a resource before entering and after leaving power-saving mode;

FIG. 8 is a diagram showing an exemplary resource table in the embodiment;

FIG. 9 is a flowchart showing a procedure in which a first CPU allocates a designated identifier to a retrieved resource in the embodiment;

FIG. 10A is a diagram describing processing in allocating an identifier to a resource;

FIG. 10B is another diagram describing the processing in allocating an identifier to a resource;

FIG. 11A is a diagram describing conventional processing in which a CPU directly managing resources allocates an identifier to a resource in resource management; and

FIG. 11B is another diagram describing the conventional processing in which a CPU directly managing resources allocates an identifier to a resource in resource management.

### DESCRIPTION OF THE EMBODIMENTS

The best mode for implementing the present invention will be described in detail below with reference to the drawings. Like components are given like reference numerals and redundant descriptions thereof are not provided.

An embodiment of the present invention will be now described.

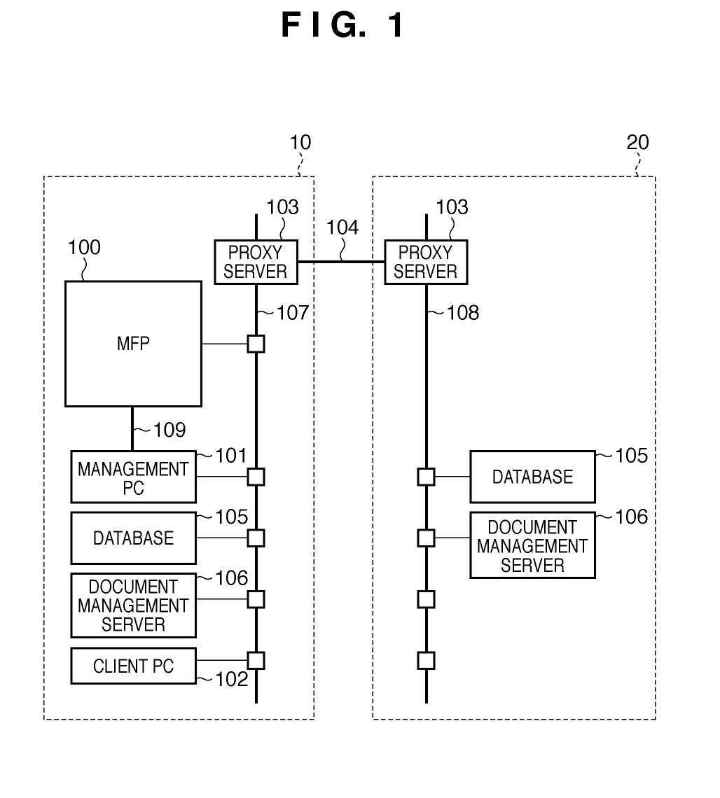

FIG. 1 is a diagram showing an exemplary system including an information processing apparatus in this embodiment according to the present invention. As shown in FIG. 1, this system is configured in such a manner that an office 10 and an office 20 are interconnected over a network 104 such as the Internet. Connected to a network 107 constructed in the office 10 are an MFP 100, a management PC 101, a client PC 102, a proxy server 103, a database 105, and a document management server 106. In this embodiment, the MFP (Multi-Function Peripheral) 100 is used as the information processing apparatus. The management PC 101 controls the MFP 100. The network 107 and a network 108 in the office 20 are connected to the network 104 via proxy servers 103. LANs are used as the networks 107 and 108, for example.

In this embodiment, the MFP 100 is responsible for reading processing for an image of a paper document and part of image processing for an image signal of the read image. The image signal is sent to the management PC 101 via a signal line 109. The management PC is a general PC that includes a storage unit, a processing unit such as a CPU, a display unit such as a display, an input unit such as a keyboard, and so on. Part of these units may be integrated into the MFP 100.

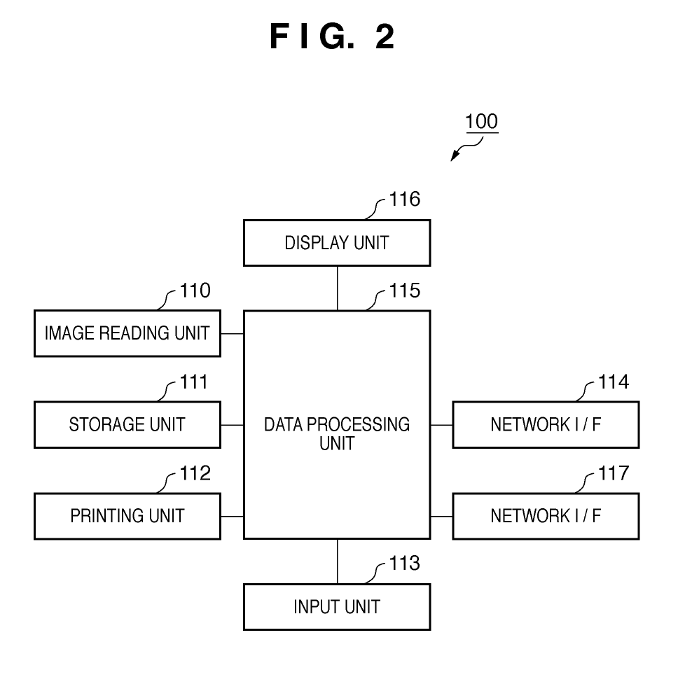

FIG. 2 is a diagram showing an internal configuration of the MFP 100 serving as the information processing apparatus. In FIG. 2, an image reading unit 110 including an auto document feeder (also referred to as an ADF hereinafter) illuminates an image of each of a batch of documents or one document with a light source (not shown) and forms a reflected image from the document onto solid-state imaging devices through a lens. As a result, a raster image-reading signal can be obtained from the solid-state imaging devices as image information at a density of 600 dpi. When a normal copy function is performed, this image signal is subjected to image processing in a data processing unit 115 and converted into a printing signal. For multi-page copy, printing data for one page is temporarily held by storing it in a storage unit 111, and sequentially output to a printing unit 112 to form an image on paper. Print data that is output from the client PC 102 is sent from the network 107 via a network interface 114 and converted into recordable raster data in the data processing unit 115. The raster data is then formed as a recorded image on paper in the printing unit 112.

Operator instructions are input from an input unit 113 that consists of a key operation unit (not shown) provided in the MFP 100. Alternatively, operator instruction may be given via an input unit that consists of a keyboard and a mouse (not shown) provided in the management PC. The above sequential operations are controlled by the data processing unit 115. The operational input state and the image data being processed are displayed on a display unit 116. The storage unit 111 is also accessible from the management PC. If the management PC 101 controls the MFP 100 in the configurations shown in FIGS. 1 and 2, the control is performed via the dedicated signal line 109 connected with a network interface 117.

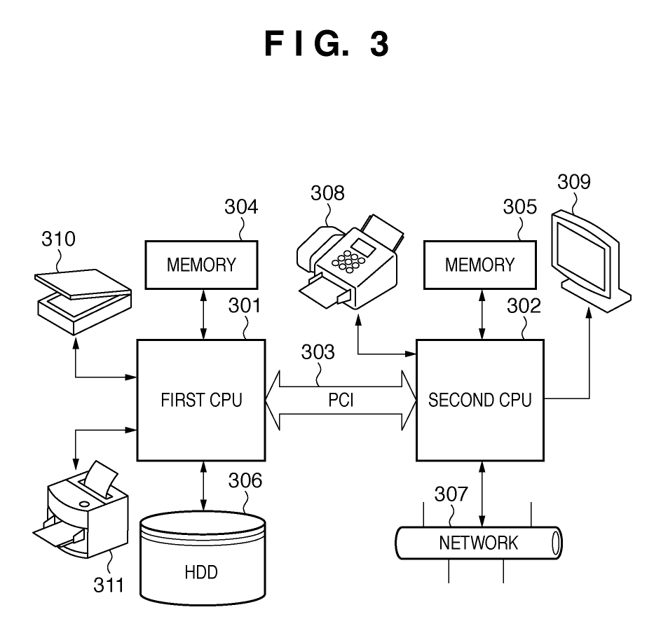

FIG. 3 is a block diagram showing a configuration of the data processing unit 115 including a plurality of CPUs. As shown in FIG. 3, the MFP 100 includes a first CPU 301 and a second CPU 302 in the data processing unit 115. The first CPU 301 controls a memory 304, an HDD 306, a scanner unit 310, and a printer unit 311. The second CPU 302 controls a memory 305, a network 307, a fax unit 308, and a display 309. The two CPUs are interconnected by a PCI bus 303 to be able to communicate with each other.

The memory 304 and 305 and the HDD 306 shown in FIG. 3 are included in the storage unit 111 shown in FIG. 2. The scanner unit 310 shown in FIG. 3 is included in the image reading unit 110 shown in FIG. 2. The printer unit 311 and the fax unit 308 shown in FIG. 3 are included in the printing unit 112 shown in FIG. 2. The display 309 shown in FIG. 3 is included in the display unit 116 shown in FIG. 2. Hereinafter, the first CPU is an example of “first processing means” in this embodiment, and the second CPU is an example of “second processing means” in this embodiment.

When the MFP 100 configured as above enters power-saving mode in response to an external instruction, a timer, or the like, the second CPU 302 controlling user interfaces, a fax line, and network communications transitions to the sleep state. Further, the first CPU 301 controlling the scanner, printer, and HDD transitions to the shutdown state. Thus, the MFP 100 including the first CPU 301 and the second CPU 302 enters power-saving mode. The following description employs the MFP 100 as the information processing apparatus. However, instead of the MFP 100, a general-purpose information processing apparatus may be used that does not include the image reading unit 110, the printing unit 112, and the network interface 117 in FIG. 2 but includes a CPU that transitions to the sleep state and a CPU that transitions to the shutdown state, for example.

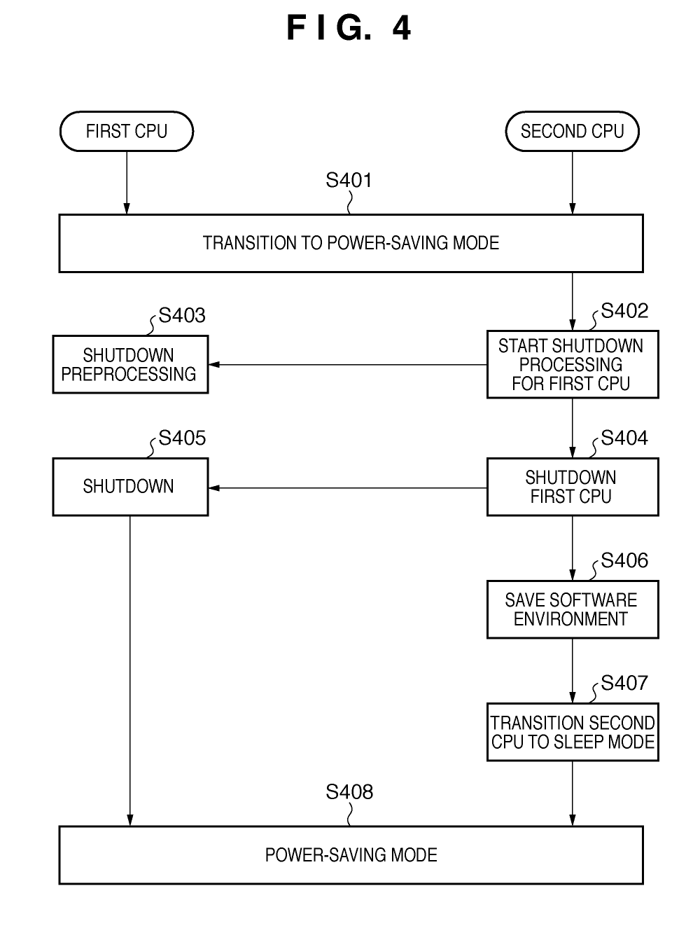

FIG. 4 is a flowchart showing a procedure in which the information processing apparatus including a plurality of CPUs transitions to power-saving mode. In this embodiment, the second CPU 302 controls the transition to power-saving mode. First, when the transition to power-saving mode is prompted by an external instruction, a timer, or the like in step S401, the second CPU 302 executes processing to shut down the first CPU 301. In step S402, the second CPU 302 starts shutdown processing for the first CPU by notifying the first CPU 301 of the transition to the shutdown state and prompting the first CPU 301 to perform shutdown preprocessing. In step S403, the first CPU 301 performs shutdown preprocessing in response to the notification of the transition to the shutdown. The second CPU 302 executes processing to shut down the first CPU 301 in step S404, and the first CPU 301 enters the shutdown state in step S405. In step S406, when the second CPU 302 finishes the processing related to transitioning the first CPU 301 to the shutdown state, the second CPU 302 performs processing of transitioning the second CPU 302 itself to the sleep state. First, the second CPU 302 saves (backs up) the current software environment in a storage area or the like so that the current state can be recovered upon returning from power-saving mode. Next, in step S407, the second CPU 302 transitions itself to the sleep state by executing an instruction to transition the second CPU 302 to the sleep state. As a result, in step S408, the information processing apparatus including the first CPU 301 and the second CPU 302 transitions to power-saving mode. In this embodiment, the sleep state refers to the state in which the CPU stops supplying clocks, executing instructions, and so on, but power is not shut down.

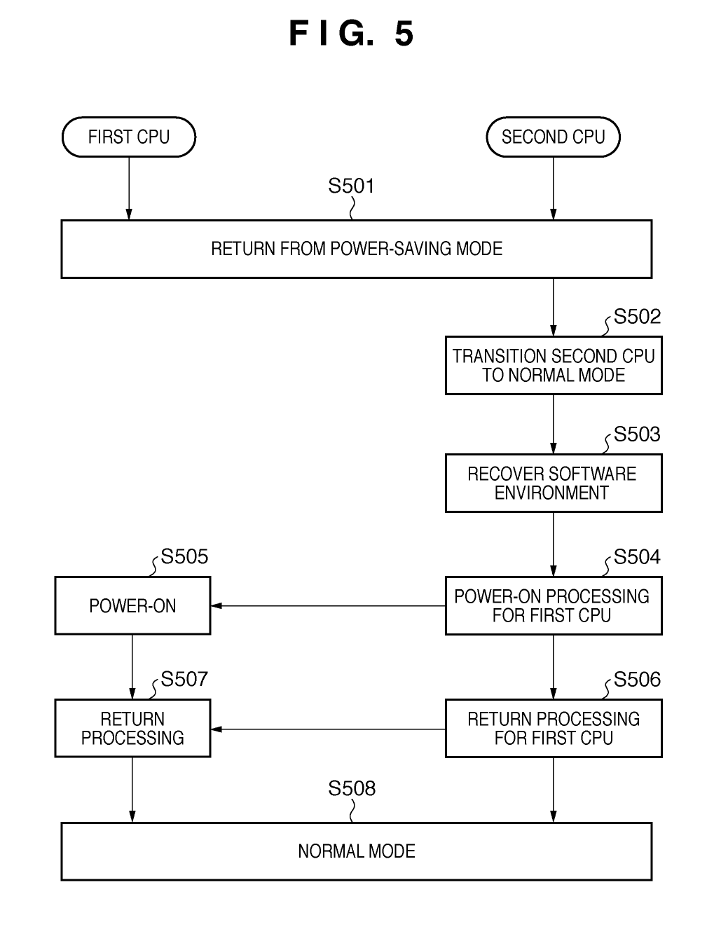

FIG. 5 is a flowchart showing a procedure in which the information processing apparatus including a plurality of CPUs returns from power-saving mode. Again in FIG. 5, as with the case of the transition to power-saving mode, the second CPU 302 controls the return from power-saving mode. First, when the return from power-saving mode is externally prompted by an interruption or the like in step S501, the second CPU 302 transitions the second CPU 302 itself from power-saving mode to normal mode in step S502. Generally, such processing is often performed not by software-implemented but by hardware-implemented power control or the like. Next, in step S503, the second CPU 302 recovers the software environment saved (backed up) in the transition to power-saving mode in step S406 shown in FIG. 4. Next, in step S504, the second CPU 302 executes processing to power on the first CPU 301 that has been in the shutdown state. Generally, such processing is implemented in hardware. The first CPU 301 is powered on in step S505, and the second CPU 302 prompts the first CPU 301 to perform return processing in step S506. In step S507, the first CPU 301 performs the processing of returning to normal mode. As a result, in step S508, the information processing apparatus including the first CPU 301 and the second CPU 302 returns from power-saving mode to normal mode. With respect to the first CPU and the second CPU described in FIGS. 4 and 5, at least one of the CPUs may be configured in the information processing apparatus.

Next, in an apparatus including a plurality of CPUs, processing in which software of a CPU accesses a resource such as a file managed by another CPU will be now described. Generally, IDs (identifiers) such as fd and socket are used for accessing CPU-managed resources such as files from software. These identifiers are associated with respective resources, thereby allowing the software to identify and access a resource by designating an identifier.

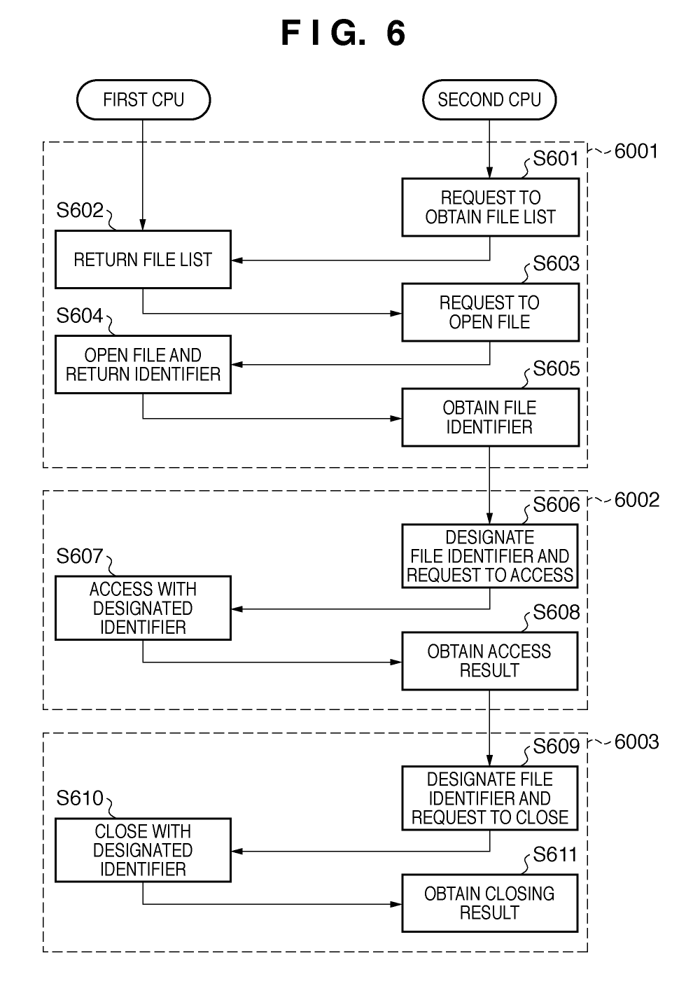

FIG. 6 is a flowchart showing a procedure for accessing a resource in a configuration including a plurality of CPUs. FIG. 6 shows processing in which software on the side of the second CPU 302 accesses a file residing in the HDD controlled by the first CPU 301. The process shown in FIG. 6 is broadly divided into three parts. Processing 6001 is a part that covers processing up to the point where the software on the side of the second CPU 302 identifies and starts accessing the file residing in the HDD controlled by the first CPU 301. In step S601, the software on the side of the second CPU 302 requests the first CPU 301 to obtain a list of files residing in the HDD. Next, in step S602, the first CPU 301 obtains the file list from the HDD and returns the file list to the software on the side of the second CPU 302. Next, in step S603, the software on the side of the second CPU 302 identifies the file to be accessed from the obtained file list and requests the first CPU 301 to open the file. In step S604, the first CPU 301 opens the requested file, generates a corresponding identifier, and returns the identifier to the software on the side of the second CPU 302. In step S605, the software on the side of the second CPU 302 obtains the file identifier. The software on the side of the second CPU 302 can hereafter use this identifier to access the file identified in step S604.

Processing 6002 is a part that covers processing in which the software on the side of the second CPU 302 accesses the file in the HDD controlled by the first CPU 301 after obtaining the identifier of the file. In step S606, the software on the side of the second CPU 302 designates the identifier obtained in the processing in the processing 6001 and requests the first CPU 301 to access the corresponding file. Next, in step S607, the first CPU 301 uses the designated identifier to access the file and returns the content of the file to the software on the side of the second CPU 302. In step S608, the software on the side of the second CPU 302 obtains the access result from the first CPU 301. Thus, in the processing 6002, the necessary file access is realized using the identifier obtained by the software on the side of the second CPU 302.

Processing 6003 is a part that covers processing in which the software on the side of the second CPU 302 terminates the access to the file in the HDD controlled by the first CPU 301. In step S609, the software on the side of the second CPU 302 designates the identifier corresponding to the file the access to which is to be terminated and requests the first CPU 301 to close the file. In step S610, the first CPU 301 uses the designated identifier to perform processing of close the file. In step S611, the software on the side of the second CPU 302 obtains the result of closing the file by the first CPU 301.

Thus, in the above processing, an identifier of a file to be accessed is first obtained (processing 6001), and the obtained identifier is then used to access the file (processing 6002). Finally, the obtained identifier is used to terminate the access to the file (processing 6003). In this manner, software on the side of the second CPU 302 can access a file in the HDD controlled by the first CPU 301.

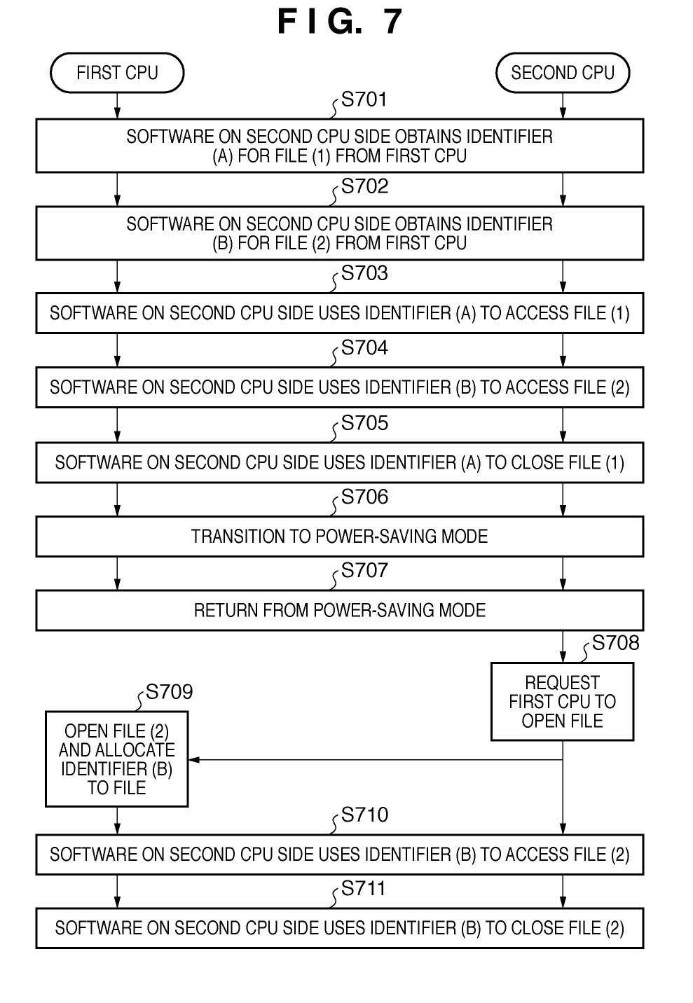

Next, a procedure for accessing a resource before entering and after leaving power-saving mode will be described. FIG. 7 is a flowchart showing the procedure of accessing a resource before entering and after leaving power-saving mode. In steps S701 and S702, software on the side of the second CPU 302 requests identifiers of a file (1) and a file (2) to the first CPU 301 and, as a result, obtains an identifier (A) and an identifier (B), respectively. This processing is performed according to the procedure described in the processing 6001 shown in FIG. 6.

Next, in steps S703 and S704, the software on the side of the second CPU 302 uses the identifier (A) to access the file (1) and uses the identifier (B) to access the file (2). When the software on the side of the second CPU 302 no more needs to access the file (1), it uses the identifier (A) to close the file (1) in step S705. This processing is performed according to the procedure described in the processing 6002 or 6003 shown in FIG. 6.

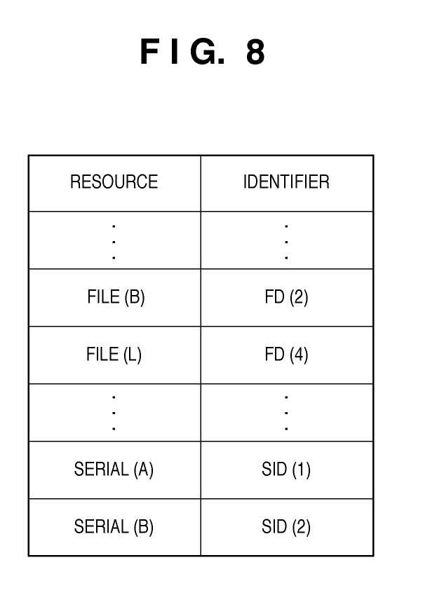

Here, it is assumed that the MFP 100 transitions to power-saving mode as shown in FIG. 4 (step S706) and thereafter returns from power-saving mode as shown in FIG. 5 (step S707). In this embodiment, as described in FIG. 4, the second CPU 302 transitions to the sleep state and the first CPU 301 transitions to the shutdown state, thereby the MFP 100 enters power-saving mode. In this embodiment, before transitioning to the sleep state, the second CPU 302 generates a resource table (also referred to as a table hereinafter) that associates currently used resources (e.g., the file (2)) and identifiers (e.g., the identifier (B)), and stores the table in the memory 305 or the like. The resource table is generated based on the correspondence between the files (resources) and the identifiers obtained in the processing 6001. The resource table will be described in FIG. 8. The resource table is generated in step S406 shown in FIG. 4, for example.

Upon returning from power-saving mode in step S707, the processing proceeds to step S708. In step S708, the software on the side of the second CPU 302 refers to the stored resource table and requests the first CPU 301 to allocate the identifier (B) to a resource (the file (2)), and also requests that this resource be opened. That is, in this embodiment, along with the request to open the file as described in step S603 shown in FIG. 6, the request to allocate the designated identifier to the resource is made to the first CPU 301.

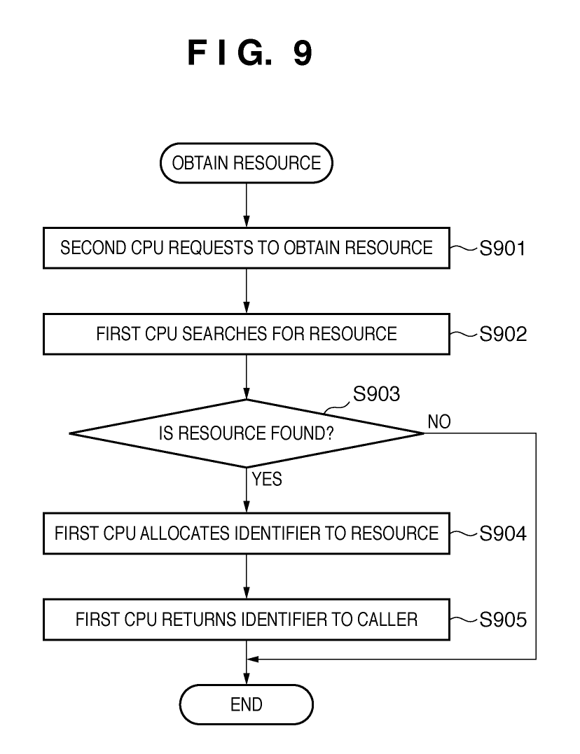

In step S709, the first CPU 301 that has received the requests allocates the identifier (B) to the file (2) and opens the file (2). Thus, in this embodiment, the first CPU 301 responds to a designation of an identifier from the second CPU 302 by retrieving a resource and allocating the designated identifier to the resource. This operation of the first CPU 301 will be described in FIG. 9.

Once step S709 is performed, the software on the side of the second CPU 302 can use the identifier (B) to access the file (2) as before the transition to power-saving mode and even after the return from power-saving mode (step S710). Further, the software on the side of the second CPU 302 can use the identifier (B) to close the file (2) (step S711). These processing parts are the same as the processing 6002 or 6003 shown in FIG. 6.

Thus, in this embodiment, the software on the side of the second CPU 302 can use a unique identifier to access a resource controlled by the first CPU 301 before entering and after leaving power-saving mode. Also, the software on the side of the second CPU 302 does not need to refer to the stored resource table after step S709. As a result, the processing time and the effect on the cache system that are caused by accessing the resource table can be reduced.

FIG. 8 is a diagram showing an exemplary resource table in this embodiment. As described above, the resource table shown in FIG. 8 is generated before the second CPU 302 transitions to the sleep state. In this embodiment, the state before the transition to power-saving mode needs to be re-created after returning from power-saving mode. For this purpose, on the side of the second CPU 302 that transitions to the sleep state, the relationship between resources and identifiers that is used in communications with the first CPU 301 is stored in the resource table as shown in FIG. 8. This table may be generated by an operating system (OS) on the side of the second CPU 302.

Files (B) and (L) shown in FIG. 8 represent files that are not closed before power-saving mode, an example of which is the file (2) shown in FIG. 7. FDs (2) and (4) are identifiers corresponding to the unclosed files, respectively, an example of which is the identifier (B) corresponding to the file (2) shown in FIG. 7. Serials (A) and (B) shown in FIG. 8 represent serial ports for communication with the scanner and the printer controlled by the first CPU 301. SIDs (1) and (2) are identifiers corresponding to the serial ports (A) and (B), respectively.

In this manner, among resources (files, serial ports, etc.) dynamically managed by the first CPU 301, those that are being accessed from the side of the second CPU 302 are associated in the table and temporarily stored before the transition to power-saving mode. Upon the return from power-saving mode, the stored table is referred to and a request to allocate a designated identifier to a resource is made to the first CPU 301 along with an access request.

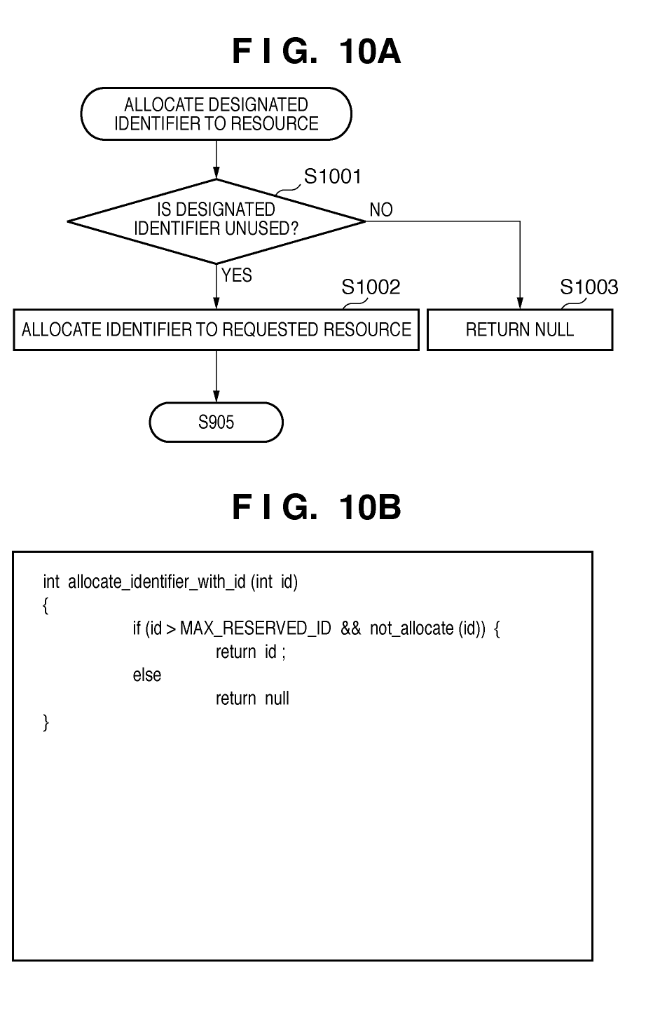

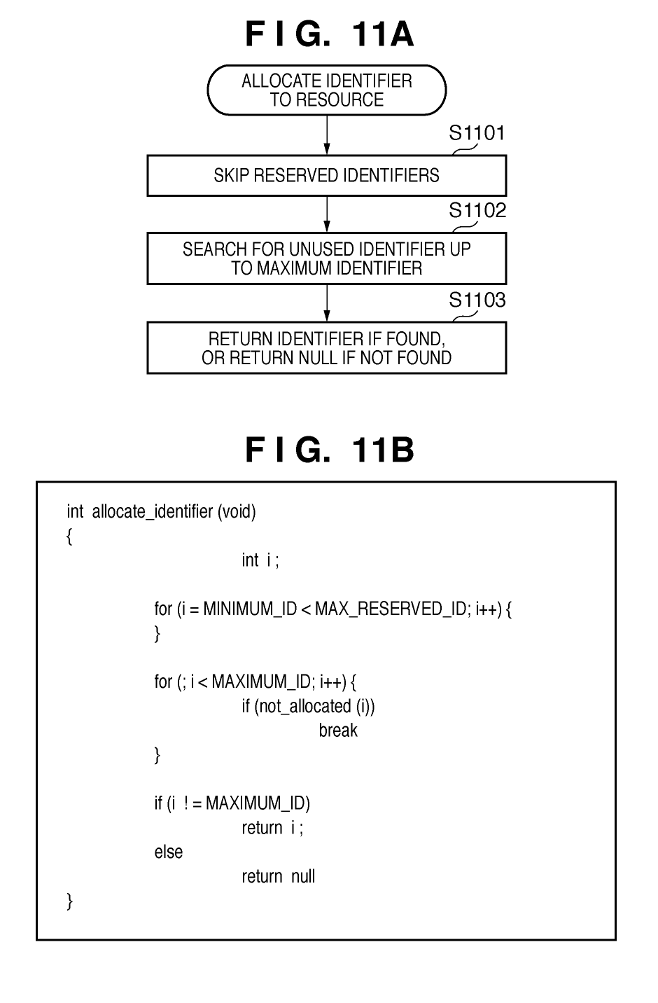

In this embodiment, the first CPU 301 retrieves the resource and allocates the identifier designated by the second CPU 302 to the resource at the request of the second CPU 302. Now, with reference to FIGS. 9, 10A, and 10B, a procedure for allocating an identifier designated by the second CPU 302 to a resource retrieved by the first CPU 301 in this embodiment will be described below.

FIG. 9 is a flowchart showing a procedure in which the first CPU 301 allocates a designated identifier to a retrieved resource. First, in step S901, a request to obtain a resource is made by the second CPU 302. This is the same as in the description in step S708 shown in FIG. 7. Next, in step S902, the first CPU 301 searches for the requested resource. In step S903, as a result of the search, it is determined whether or not the requested resource exists. If it is determined that the requested resource exists, the processing proceeds to step S904. If it is determined that the requested resource does not exist, the processing terminates. For example, this is the case where a USB memory has been removed when a request to access a file or the like in the USB memory is received.

In step S904, the first CPU 301 allocates an identifier designated by the second CPU 302 to the requested resource.

Here, the processing in step S904 will be described with reference to FIGS. 10A and 10B. FIG. 10A is a flowchart showing a procedure in which the first CPU 301 allocates the identifier to the resource. First, in step S1001, the first CPU 301 determines whether or not the designated identifier is unused. Generally, the first CPU 301 manages resources by automatically allocating an identifier arbitrarily extracted from identifiers in a certain range to each resource controlled by the first CPU 301 itself. Therefore, it is necessary to determine in step S1001 whether or not the identifier designated by the second CPU 302 is unused. If it is determined that the identifier is unused, the processing proceeds to step S1002. If it is determined that the identifier is not unused, “null” (e.g., “0”) is returned to the second CPU 302 in step S1003 and the processing terminates. In step S1002, the first CPU 301 allocates the identifier designated by the second CPU 302 to the requested resource, and returns the designated identifier to the caller (i.e., software on the side of the second CPU 302) in step S905. FIG. 10B is a diagram showing an example in which the operation of the flowchart shown in FIG. 10A is coded. FIG. 10B shows the part of the determination processing in step S1001 and the part of returning either the designated identifier “id” or “null”. Here, “id” is a dummy argument representing the identifier designated by the caller (i.e., the software on the side of the second CPU 302).

Thus, in this embodiment, when the MFP 100 transitions to power-saving mode, the table as shown in FIG. 8 that associates currently used identifiers and resources is generated and temporarily stored. After the MFP 100 returns from power-saving mode, software on the side of the second CPU 302 refers to the table shown in FIG. 8 to make a request to allocate a designated identifier to a resource, along with an access request, to the first CPU 301. The first CPU 301 receives the requests and performs the processing as shown in FIGS. 9, 10A, and 10B. According to the above-described operation, it is possible in an information processing apparatus including both a sleep-state CPU and a shutdown-state CPU to use unique identifiers to manage resources controlled by the CPUs before entering and after leaving power-saving mode. Also, once the software on the side of the second CPU 302 accesses a resource managed by the first CPU for the first time after the return from power-saving mode, it is not necessary to repeatedly refer to the stored resource table. Therefore, the processing time and the effect on the cache system that are caused by accessing the resource table can be reduced.

The present invention also includes the case where an operating system (OS) or the like running on the computer performs part or all of the actual processing under instructions of a program (information processing program) code to implement the functions of the above-described embodiment. Further, the present invention is also applied to the case where the program code read out from a storage medium is written to memory provided in a function extension card inserted into a computer or in a function extension unit connected to a computer. In this case, a CPU or the like provided in the function extension card or function extension unit performs part or all of actual processing under instructions of the written program code to implement the functions of the above-described embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-114418, filed Apr. 24, 2008, which is hereby incorporated by reference herein in its entirety.

What is claimed is:

1. An information processing apparatus comprising at least one first processing unit that manages a resource and at least one second processing unit that accesses the resource, wherein
said second processing unit
stores a table in which an identifier identifying the resource is associated with the resource, and
when accessing the resource, refers to the table and requests said first processing unit to allocate the identifier associated with the resource to the resource.

2. The information processing apparatus according to claim 1, wherein said first processing unit allocates the identifier to the resource at the request of said second processing unit.

3. The information processing apparatus according to claim 1, wherein when said second processing unit accesses the resource for the first time after returning from power-saving mode in which said first processing unit has been in a shutdown state and said second processing unit has been in a sleep state,
said second processing unit
refers to the table and requests said first processing unit to allocate an identifier associated with the resource to the resource.

4. The information processing apparatus according to claim 3, wherein before entering the sleep state, said second processing unit stores the table in which the identifier is associated with the resource.

5. The information processing apparatus according to claim 3, wherein said second processing unit causes said first processing unit to enter the shutdown state, and thereby said information processing apparatus enters power-saving mode.

6. An information processing method performed in an information processing apparatus comprising at least one first CPU that manages a resource and at least one second CPU that accesses the resource, the method comprising the steps of:
storing a table in which an identifier identifying the resource is associated with the resource, and
referring to the table and requesting said first CPU to allocate an identifier associated with the resource to the resource when accessing the resource.

7. A computer-readable medium storing an information processing program thereon, wherein
in a computer comprising at least one first CPU that manages a resource and at least one second CPU that accesses the resource, the program causes said second CPU to function to:
store a table in which an identifier identifying the resource is associated with the resource, and
when accessing the resource, refer to the table and request said first CPU to allocate the identifier associated with the resource to the resource.
